(19) United States
(12) Patent Application Publication
(10) Pub. No.: US 2011/0029281 A1
(43) Pub. Date: Feb. 3, 2011

(54) Link travel time calculation device and method for calculating link travel time interval

(75) Inventors: Akira Tsukamoto, Kariya-city (JP); Iwao Tanahashi, Nisshin-city (JP); Mathieu Lenoble, Nisshin-city (JP); Eiji Teramoto, Nagoya-city (JP); Hironobu Kitaoka, Nisshin-city (JP); Hiroko Mori, Aichi-gun (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/801,873

(22) Filed: Jun. 29, 2010

(30) Foreign Application Priority Data
Jul. 13, 2009 (JP) 2009-164733

(51) Int. Cl. G06F 15/00; G04F 10/00

(52) U.S. Cl. 702/176

(57) ABSTRACT

A link travel time calculation device includes: a collection element for collecting a travel position and a transit time in each vehicle; and a link travel time calculation element. The calculation element calculates a total travel time interval of all sections based on the travel position and the transit time in a predetermined time period. The calculation element calculates a first travel time interval of an upstream section and a second travel time interval of a downstream section based on the travel position and the transit time. The calculation element calculates a travel time interval of the object link with respect to the predetermined time period by subtracting a sum of the first travel time interval and the second travel time interval from the total travel time interval.

### CROSS REFERENCE TO RELATED APPLICATION

This application is based on Japanese Patent Application No. 2009-164733 filed on Jul. 13, 2009, the disclosure of which is incorporated herein by reference.

### FIELD OF THE INVENTION

The present invention relates to a link travel time calculation device and a program. Specifically, the invention relates to the link travel time calculation device and the program for calculating a link travel time interval of an object link based on collected traveling data.

### BACKGROUND OF THE INVENTION

Conventionally, a method for calculating a corrected travel time interval is known with an object of calculation of a total travel time interval of a travel route (Patent document No. 1). The corrected travel time interval is obtained by correcting a travel time interval in each section between adjacent points in such a manner that a parameter according to environment and conditions is applied to collection of past data about transit time and average travel speed between adjacent pass points of the travel route. In the calculation method of the travel time interval, it is possible to calculate the travel time interval according to change of a specific traffic situation under a condition such as a day of the week, hours of a day and weather.

Further, a method for developing a precise link cost function is known such that the link cost function used for traffic volume distribution is estimated with using travel time data obtained from a probe vehicle and traffic volume data obtained form a vehicle detector (Non patent document No. 1).

In the above method, the link cost function is estimated such that a distance of an observation section of the travel time interval is lengthened so that influence of a traffic signal is averaged.

[Patent document No. 1] JP-A-2002-342874

[Non patent document No. 1] “Study for estimation of a link cost function with using probe vehicle data,” by Yoshiyuki Okada et al., Paper collection of study about civil engineering planning, 2004

However, in the above technique described in the Patent document No. 1, it is a problem such that it is impossible to calculate the travel time reflecting occurrence of traffic jams and unexpected change of traffic conditions in real time. The traffic jams are caused by traffic concentration at a time when an event is held. The unexpected change is caused by traffic accident or road works.

Further, in the above technique described in the Non patent document No. 1, an effect is obtained such that variation of calculation of the travel time interval is reduced because of extension of the observation section. However, it is a problem such that it is impossible to calculate the travel time interval in each link with high accuracy since the link cost function is estimated on the assumption that a vehicle drives with a constant travel speed (i.e., average travel speed) in all of the intervals of the observation section.

### SUMMARY OF THE INVENTION

In view of the above-described problem, it is an object of the present disclosure to provide a link travel time calculation device for calculating a link travel time interval with high accuracy and reflecting a traffic situation in real time and a program for the same.

According to a first aspect of the present disclosure, a link travel time calculation device includes: a collection element for collecting a travel position and a transit time at the travel position in each vehicle, which are measured individually among a plurality of vehicles; and a link travel time calculation element. The link travel time calculation element calculates a total travel time interval of all sections based on the travel position and the transit time, which are collected by the collection element in a predetermined time period. The all sections includes an object link, an upstream section disposed on an upstream side of the object link, and a downstream section disposed on a downstream side of the object link. The link travel time calculation element calculates a first travel time interval of the upstream section based on the travel position and the transit time. The link travel time calculation element calculates a second travel time interval of the downstream section based on the travel position and the transit time. The link travel time calculation element calculates a travel time interval of the object link with respect to the predetermined time period by subtracting a sum of the first travel time interval and the second travel time interval from the total travel time interval.

In the above case, a difference between the travel time interval of all sections including the upstream section and the downstream section of the object link in the predetermined time period, and a sum of the travel time interval of the upstream section and the travel time interval of the downstream section in the predetermined time period is calculated so that the link travel time interval reflecting the traffic situation in real time is calculated with high accuracy.

Alternatively, each vehicle may include a GPS sensor and a wireless communication unit. The collection element collects the travel position and the transmit time, which are transmitted from each vehicle and measured by the GPS sensor in each vehicle. Further, the collection element may verify the travel position measured in each vehicle with road map data, which is preliminary prepared, so that the collection element collects the travel position of each vehicle as a position of a road map.

According to a second aspect of the present disclosure, a link travel time calculation device includes: a collection element for collecting a travel position and a transit time at the travel position in each vehicle, which are measured individually among a plurality of vehicles; and a link travel time calculation element. The link travel time calculation element calculates a third travel time interval of a link upstream section based on the travel position and the transit time, which are collected by the collection element in a predetermined time period. The link upstream section includes an object link and an upstream section disposed on an upstream side of the object link. The link travel time calculation element calculates a fourth travel time interval of a link downstream section based on the travel position and the transit time, which are collected by the collection element in the predetermined time period. The link downstream section includes the object link and a downstream section disposed on a downstream side of the object link. The link travel time calculation element calculates a total travel time interval of all sections based on the travel position and the transit time. The all sections include the object link, the upstream section and the downstream section. The link travel time calculation element calculates a travel time interval of the object link with respect to the predetermined time period by subtracting the third travel time interval and the fourth travel time interval from the total travel time interval.

In the above case, a difference between the travel time interval of all sections in the predetermined time period and a sum of the travel time interval of the upstream section and the travel time interval of the downstream section in the predetermined time period is calculated so that the link travel time interval reflecting the traffic situation in real time is calculated with high accuracy.

According to a third aspect of the present disclosure, a link travel time calculation device includes: a collection element for collecting a travel position and a transit time at the travel position in each vehicle, which are measured individually among a plurality of vehicles; and a link travel time calculation element. The link travel time calculation element calculates a fifth travel time interval of a link downstream section based on the travel position and the transit time, which are collected by the collection element in a predetermined time period. The link downstream section includes an object link and a downstream section disposed on a downstream side of the object link. The link travel time calculation element calculates a sixth travel time interval of the downstream section based on the travel position and the transit time. The link travel time calculation element calculates a travel time interval of the object link with respect to the predetermined time period by subtracting the sixth travel time interval from the fifth travel time interval.

In the above case, a difference between the travel time interval of the link downstream section including the object link in the predetermined time period and the travel time interval of the downstream section in the predetermined time period is calculated so that the link travel time interval reflecting the traffic situation in real time is calculated with high accuracy.

According to a fourth aspect of the present disclosure, a link travel time calculation device includes: a collection element for collecting a travel position and a transit time at the travel position in each vehicle, which are measured individually among a plurality of vehicles; and a link travel time calculation element. The link travel time calculation element calculates a seventh travel time interval of a link upstream section based on the travel position and the transit time, which are collected by the collection element in a predetermined time period. The link upstream section includes an object link and an upstream section disposed on an upstream side of the object link. The link travel time calculation element calculates an eighth travel time interval of the upstream section based on the travel position and the transit time. The link travel time calculation element calculates a travel time interval of the object link with respect to the predetermined time period by subtracting the eighth travel time interval from the seventh travel time interval.

In the above case, a difference between the travel time interval of the link upstream section including the object link in the predetermined time period and the travel time interval of the upstream section in the predetermined time period is calculated so that the link travel time interval reflecting the traffic situation in real time is calculated with high accuracy.

According to a fifth aspect of the present disclosure, a link travel time calculation device includes: a collection element for collecting a travel position and a transit time at the travel position in each vehicle, which are measured individually among a plurality of vehicles; a calculation method selection element; and a link travel time calculation element. The calculation method selection element selects one of a first calculation method, a second calculation method, a third calculation method and a fourth calculation method according to a current traffic situation of an object link and a past traffic situation of the object link. The link travel time calculation element calculates a travel time interval of the object link with respect to a predetermined time period according to the selected one of the first to fourth calculation methods. The first calculation method includes: calculating a total travel time interval of all sections based on the travel position and the transit time, which are collected by the collection element in the predetermined time period, wherein the all sections includes the object link, an upstream section disposed on an upstream side of the object link, and a downstream section disposed on a downstream side of the object link; calculating a first travel time interval of the upstream section based on the travel position and the transit time; calculating a second travel time interval of the downstream section based on the travel position and the transit time, and calculating a travel time interval of the object link with respect to the predetermined time period by subtracting a sum of the first travel time interval and the second travel time interval from the total travel time interval. The second calculation method includes: calculating a third travel time interval of a link upstream section based on the travel position and the transit time, wherein the link upstream section includes the object link and the upstream section disposed on the upstream side of the object link; calculating a fourth travel time interval of a link downstream section based on the travel position and the transit time, wherein the link downstream section includes the object link and the downstream section disposed on the downstream side of the object link; calculating the total travel time interval of all sections based on the travel position and the transit time, wherein the all sections includes the object link, the upstream section and the downstream section; and calculating the travel time interval of the object link with respect to the predetermined time period by subtracting the third travel time interval and the fourth travel time interval from the total travel time interval. The third calculation method includes: calculating a fifth travel time interval of the link downstream section based on the travel position and the transit time; wherein the link downstream section includes the object link and the downstream section disposed on the downstream side of the object link; calculating a sixth travel time interval of the downstream section based on the travel position and the transit time; and calculating the travel time interval of the object link with respect to the predetermined time period by subtracting the sixth travel time interval from the fifth travel time interval. The fourth calculation method includes: calculating a seventh travel time interval of the link upstream section based on the travel position and the transit time, wherein the link upstream section includes the object link and the upstream section disposed on the upstream side of the object link; calculating an eighth travel time interval of the upstream section based on the travel position and the transit time; and calculating the travel time interval of the object link with respect to the predetermined time period by subtracting the eighth travel time interval from the seventh travel time interval.

In the above case, the link travel time interval of the object link is calculated according to the selected calculation method based on the past traffic situation or the current traffic situation of the object link so that the link travel time interval reflecting the traffic situation in real time is calculated with high accuracy.

According to a sixth aspect of the present disclosure, a method for calculating a travel time interval of an object link comprising: collecting a travel position and a transit time at the travel position in each vehicle, which are measured individually among a plurality of vehicles; calculating a total travel time interval of all sections based on the travel position and the transit time, which are collected in a predetermined time period, wherein the all sections includes the object link, an upstream section disposed on an upstream side of the object link, and a downstream section disposed on a downstream side of the object link; calculating a first travel time interval of the upstream section based on the travel position and the transit time; calculating a second travel time interval of the downstream section based on the travel position and the transit time, and calculating the travel time interval of the object link with respect to the predetermined time period by subtracting a sum of the first travel time interval and the second travel time interval from the total travel time interval.

In the above case, a difference between the travel time interval of all sections including the upstream section and the downstream section of the object link in the predetermined time period, and a sum of the travel time interval of the upstream section and the travel time interval of the downstream section in the predetermined time period is calculated so that the link travel time interval reflecting the traffic situation in real time is calculated with high accuracy.

According to a seventh aspect of the present disclosure, a method for calculating a travel time interval of an object link includes: collecting a travel position and a transit time at the travel position in each vehicle, which are measured individually among a plurality of vehicles; calculating a third travel time interval of a link upstream section based on the travel position and the transit time, which are collected in a predetermined time period, wherein the link upstream section includes the object link and an upstream section disposed on an upstream side of the object link; calculating a fourth travel time interval of a link downstream section based on the travel position and the transit time, wherein the link downstream section includes the object link and a downstream section disposed on a downstream side of the object link; calculating a total travel time interval of all sections based on the travel position and the transit time, wherein the all sections includes the object link, the upstream section and the downstream section; and calculating the travel time interval of the object link with respect to the predetermined time period by subtracting the third travel time interval and the fourth travel time interval from the total travel time interval.

In the above case, a difference between the travel time interval of all sections in the predetermined time period and a sum of the travel time interval of the upstream section and the travel time interval of the downstream section in the predetermined time period is calculated so that the link travel time interval reflecting the traffic situation in real time is calculated with high accuracy.

According to an eighth aspect of the present disclosure, a method for calculating a travel time interval of an object link comprising: collecting a travel position and a transit time at the travel position in each vehicle, which are measured individually among a plurality of vehicles; calculating a fifth travel time interval of a link downstream section based on the travel position and the transit time, which are collected in a predetermined time period, wherein the link downstream section includes the object link and a downstream section disposed on a downstream side of the object link; calculating a sixth travel time interval of the downstream section based on the travel position and the transit time; and calculating the travel time interval of the object link with respect to the predetermined time period by subtracting the sixth travel time interval from the fifth travel time interval.

In the above case, a difference between the travel time interval of the link downstream section including the object link in the predetermined time period and the travel time interval of the downstream section in the predetermined time period is calculated so that the link travel time interval reflecting the traffic situation in real time is calculated with high accuracy.

According to a ninth aspect of the present disclosure, a method for calculating a travel time interval of an object link includes: collecting a travel position and a transit time at the travel position in each vehicle, which are measured individually among a plurality of vehicles; calculating a seventh travel time interval of a link upstream section based on the travel position and the transit time, which are collected in a predetermined time period, wherein the link upstream section includes the object link and an upstream section disposed on an upstream side of the object link; calculating an eighth travel time interval of the upstream section based on the travel position and the transit time; and calculating the travel time interval of the object link with respect to the predetermined time period by subtracting the eighth travel time interval from the seventh travel time interval.

In the above case, a difference between the travel time interval of the link upstream section including the object link in the predetermined time period and the travel time interval of the upstream section in the predetermined time period is calculated so that the link travel time interval reflecting the traffic situation in real time is calculated with high accuracy.

According to a tenth aspect of the present disclosure, a method for calculating a travel time interval of an object link includes: collecting a travel position and a transit time at the travel position in each vehicle, which are measured individually among a plurality of vehicles; selecting one of a first calculation method, a second calculation method, a third calculation method and a fourth calculation method according to a current traffic situation of the object link and a past traffic situation of the object link; and calculating the travel time interval of the object link with respect to a predetermined time period according to the selected one of the first to fourth calculation methods. The first calculation method includes: calculating a total travel time interval of all sections based on the travel position and the transit time, which are collected by the collection element in the predetermined time period, wherein the all sections includes the object link, an upstream section disposed on an upstream side of the object link, and a downstream section disposed on a downstream side of the object link; calculating a first travel time interval of the upstream section based on the travel position and the transit time; calculating a second travel time interval of the downstream section based on the travel position and the transit time, and calculating a travel time interval of the object link with respect to the predetermined time period by subtracting a sum of the first travel time interval and the second travel time interval from the total travel time interval. The second calculation method includes: calculating a third travel time interval of a link upstream section based on the travel position and the transit time, wherein the link upstream section includes the object link and the upstream section disposed on the upstream side of the object link; calculating a fourth travel time interval of a link downstream section based on the travel position and the transit time, wherein the link downstream section includes the object link and the downstream section disposed on the downstream side of the object link; calculating the total travel time interval of all sections based on the travel position and the transit time, wherein the all sections includes the object link, the upstream section and the downstream section; and calculating the travel time interval of the object link with respect to the predetermined time period by subtracting the third travel time interval and the fourth travel time interval from the total travel time interval. The third calculation method includes: calculating a fifth travel time interval of the link downstream section based on the travel position and the transit time; wherein the link downstream section includes the object link and the downstream section disposed on the downstream side of the object link; calculating a sixth travel time interval of the downstream section based on the travel position and the transit time; and calculating the travel time interval of the object link with respect to the predetermined time period by subtracting the sixth travel time interval from the fifth travel time interval. The fourth calculation method includes: calculating a seventh travel time interval of the link upstream section based on the travel position and the transit time, wherein the link upstream section includes the object link and the upstream section disposed on the upstream side of the object link; calculating an eighth travel time interval of the upstream section based on the travel position and the transit time; and calculating the travel time interval of the object link with respect to the predetermined time period by subtracting the eighth travel time interval from the seventh travel time interval.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a traffic information generating system according to a first embodiment;

FIG. 2A is a diagram showing a first calculation method for calculating a link travel time interval, FIG. 2B is a diagram showing a second calculation method for calculating a link travel time interval, and FIG. 2C is a diagram showing a third calculation method for calculating a link travel time interval;

FIG. 3 is a flow chart showing a content of a probe vehicle information collection process routine in the traffic information generating device according to the first embodiment;

FIG. 4 is a flow chart showing a content of a link travel time interval calculation process routine in the traffic information generating device according to the first embodiment;

FIG. 5 is a graph showing a result of a comparison example for calculating a link travel time interval according to a simulation;

FIG. 6 is a graph showing a result of calculation of a sectional travel time interval according to a simulation;

FIG. 7 is a graph showing a relationship between a probe vehicle adoption rate and an average error rate of the link travel time interval; and

FIG. 8 is a diagram showing another example of a third calculation method for calculating the link travel time interval.

### DETAILED DESCRIPTION OF THE PREFERRED EMBODIMENTS

Preferred embodiments of the present invention will be explained with reference to drawings. An example will be explained that a present invention is applied to a traffic information generating system for generating traffic information representing a link travel time interval of each link.

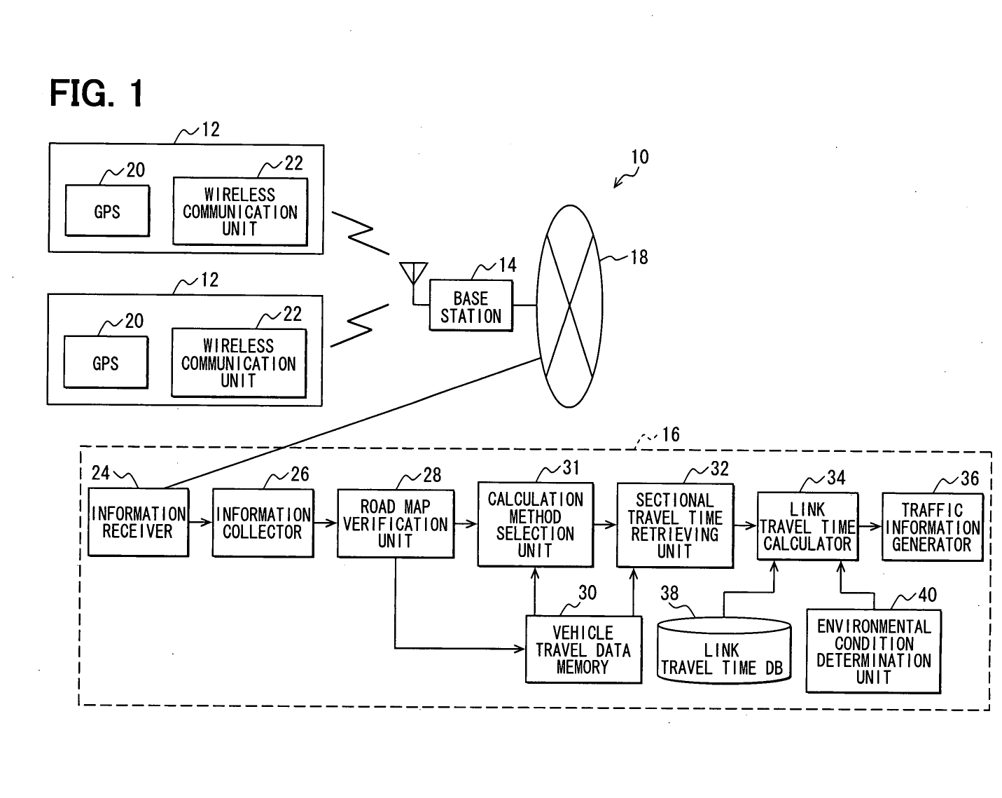

As shown in FIG. 1, a traffic information generating system 10 according to a first embodiment includes multiple probe vehicles 12, multiple base stations 14 for wireless communicating with an element disposed on a road side, and a traffic information generating device 16 disposed on a traffic information center side. Further, each base station 14 and the traffic information generating device 16 are coupled with each other via a communication line 18.

Each probe vehicle 12 includes a GPS sensor 20 for measuring a position of a subject vehicle, and a wireless communication unit 22, which transmits probe vehicle information in wireless communication. The probe vehicle information includes subject vehicle position information measured by the GPS sensor 20, transit time at a position shown in the subject vehicle position information measure by a measurement unit (not shown), and a vehicle ID for identifying the subject vehicle. Each probe vehicle 12 transmits the probe vehicle information at predetermined time periods.

Each base station 14 receives the probe vehicle information transmitted from the wireless communication unit 22 of the probe vehicle 12. Further, the base station 14 transmits the received probe vehicle information to the traffic information generating device 16 via the communication line 18.

The traffic information generating device 16 includes a conventional server so that the device 16 includes a CPU, a RAM, a ROM and a HDD. The ROM stores a program for executing a probe vehicle information collection process routine and a link travel time interval calculation process routine. The traffic information generating device 16 has a following functional construction. The traffic information generating device 16 includes an information receiving unit 24, an information collecting unit 26, a road map verifying unit 28, a vehicle travel data memorizing unit 30, a calculation method selecting unit 31, a section travel time interval retrieving unit 32, a link travel time interval calculating unit 34 and a traffic information generating unit 36. The information receiving unit 24 receives the probe vehicle information transmitted from the probe vehicle 12. The information collecting unit 26 collects the probe vehicle information received by the information receiving unit 24. The road map verifying unit 28 verifies a travel position of the probe vehicle information with road map data so that a position on the road map is specified. Further, the unit 28 stores the specified position in the vehicle travel data memorizing unit 30. The vehicle travel data memorizing unit 30 stores vehicle travel data including the travel position on the road map, a transit time in the probe vehicle information, and the vehicle ID. The calculation method selecting unit 31 determines the traffic situation of the object link based on the vehicle travel data stored in the vehicle travel data memorizing unit 30, and selects a calculation method of the link travel time interval. The section travel time interval retrieving unit 32 retrieves the section travel time interval based on the vehicle travel data stored in the vehicle travel data memorizing unit 30 in order to calculate the travel time interval of the object link. The link travel time interval calculating unit 34 calculates the link travel time interval with using the section travel time interval. The traffic information generating unit 36 generates the traffic information including the link travel time interval in each link.

The traffic information generating device 16 further includes a link travel time interval DB 38, and an environmental condition determining unit 40. The DB 38 stores the link travel time interval in each link; which was measured in the past. The determining unit 40 determines environmental conditions such as a day of the week, hours of a day and weather.

The information collecting unit 26 collects the probe vehicle information transmitted from multiple probe vehicles 12.

The road map verifying unit 28 verifies the travel position in the collected probe vehicle information with the road map shown in the road map data every time when the probe vehicle information is collected.

Thus, the unit 28 specifies the travel position on the road map, and further, the unit 28 stores the vehicle travel data including the specified travel position on the road map, the transit time in the probe vehicle information, the vehicle ID in the vehicle travel data memorizing unit 30.

Here, the operating principle of the present embodiment will be explained.

The link travel time interval is necessary for searching a route in a vehicle navigation system. However, the traffic information of the VICS is limited to a highway and a main road. Thus, when the traffic information about an ordinary road is collected, the traffic information collecting system with using the probe vehicle is available. In the traffic information collecting system with using the probe vehicle, when the link travel time interval is obtained from the probe vehicle information, the link travel time interval represents driving time interval of a vehicle (i.e., the probe vehicle), which runs through the link. In general, the driving time interval varies between vehicles. Mainly, the traffic lights much affect the variation. Specifically, when needed time interval from one intersection to next intersection is measured, the link travel time interval in a case where the vehicle passes through the intersection on a green light is much different from the link travel time interval in a case where the vehicle stops on a red light so that it is necessary to wait for a green light. Accordingly, when the link travel time interval is obtained from only one probe vehicle, the value of the time interval may have a large variation with respect to an average value of the link travel time interval of all vehicles.

On the other hand, variation of the section travel time interval including multiple traffic intersections is comparatively small, compared with the link travel time interval since the influence of the traffic lights on the vehicle driving is averaged.

In the present embodiment, in view of the above features, a method for calculating the link travel time interval is as follows. The link travel time interval is calculated by calculating a difference of section travel time interval between different sections of two points based on the travel time interval of all sections including the object link and the section travel time interval including an upstream section or a downstream section of the object link.

Specifically, the calculation method of the link travel time interval of the object link is one of three calculation methods described below with using the travel time interval of all sections including the object link, the section travel time interval including the upstream section or the downstream section of the object link.

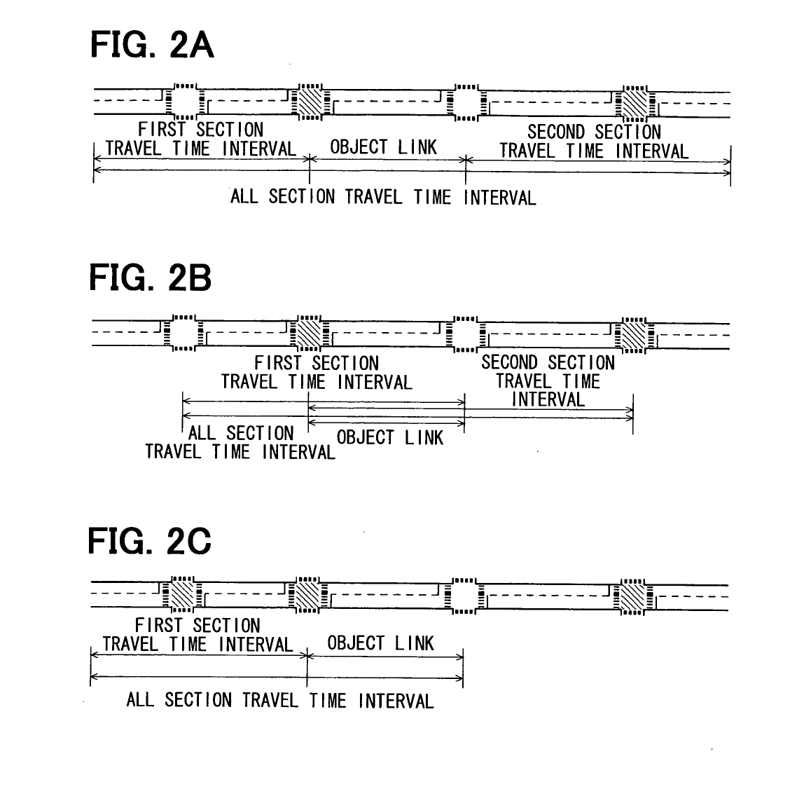

In the first calculation method, as shown in FIG. 2A and the formula No. 1, the link travel time interval of the object link is calculated by subtracting a sum of the first section travel time interval of the upstream section and the second section travel time interval of the downstream section from the travel time interval of all sections including the object link, the upstream section disposed on the upstream side of the object link and the downstream section disposed on the downstream side of the object link.

(link travel time interval of object link)=(all section travel time interval)−(first section travel time interval+second section travel time interval) F1

In the second calculation method, as shown in FIG. 2B and the formula No. 2, the link travel time interval of the object link is calculated by subtracting the travel time interval of all sections from a sum of the first section travel time interval and the second section travel time interval with using the travel time interval of all sections including the object link, the upstream link disposed on the upstream side of the object link and the downstream link disposed on the downstream side of the object link, the first section travel time interval including the object link and the upstream link, and the second section travel time interval including the object link and the downstream link.

(link travel time interval of object link)=(first section travel time interval+second section travel time interval)−(all section travel time interval) F2

In the third calculation method, as shown in FIG. 2C and a formula No. 3, the link travel time interval of the object link is calculated by subtracting the first section travel time interval of the upstream section from all section travel time interval including the object link and the upstream section disposed on the upstream side of the object link.

(link travel time interval of object link)=(all section travel time interval)−(first section travel time interval) F3

Next, a method for selecting one calculation method among three calculation methods of the link travel time interval will be explained.

First, the above first calculation method is selected as a basic selection of the calculation method of the link travel time interval. This is because the number of links in all sections increases (for example, five links shown in FIG. 2A) so that an effect of averaging the variation of the link travel time interval in each vehicle is utilized at a maximum.

The second calculation method is selected in a traffic situation such that the traffic volume of the object link is small, and the probe vehicle information is utilized under a condition that the traffic volume is small so that it is difficult to retrieve the probe vehicle running through all sections in the first calculation method (five links in an example shown in FIG. 2A). For example, when there is no probe vehicle running through all sections in the first calculation method during an update interval of the traffic information, the above second calculation method is selected. Alternatively, the second calculation method is selected under a condition such that traffic jam occurs in the object link or the object link is crowded, and a necessary time for obtaining the section travel time interval exceeds the update interval if the traffic information. For example, when the update interval of the traffic information is five minutes, it is necessary to obtain the section travel time interval within a time shorter than five minutes. Thus, the second calculation method is selected under the traffic situation such that the travel time interval of all sections in the first calculation method is equal to or larger than the update interval since it is possible to obtain the travel time interval of all sections in a short time in the second calculation method.

Further, under a traffic situation such that the traffic volume increases, and the traffic jam expands, the traffic situation on the upstream side of the link is much different from the traffic situation on the downstream side when the link is a front of the jam. The determination of such traffic situation is performed in view of difference of average driving speed introduced from the travel time interval of all sections (three links in an example of FIG. 2B) used in the second calculation method. For example, the third calculation method is selected in a traffic situation such that a traffic jam occurs in a section including the object link, and zones in which the average driving speed is equal to or smaller than 20 km/h are continuously observed. In the third calculation method, the link travel time interval is calculated with using the travel time interval of the section including the traffic jam generating section and a section on an upstream side of the traffic jam generating section.

In the present embodiment, the calculation method selecting unit 31 determines the traffic situation of the object link based on the vehicle driving data around the object link in the predetermined time period (which is the same period as the update interval of the traffic information, e.g., five minutes), which is stored in the vehicle driving data memorizing unit 30. The unit 31 selects one of the first to third calculation methods at every predetermined time period, as described above.

The section travel time interval retrieving unit 32 retrieves the travel time interval of all sections in accordance with the selected calculation method and the first section travel time interval of the upstream section or the second section travel time interval of the downstream section in accordance with the selected calculation method at every predetermined time period based on the vehicle driving data around the object link in the predetermined time period stored in the vehicle driving data memorizing unit 30.

For example, when the first calculation method is selected with respect to the object link, the average value of the travel time interval of all sections is retrieved as all section travel time interval. The average value is calculated based on the vehicle driving data of all probe vehicles 12, which passes through all sections in a predetermined time period. Further, the average value of the travel time interval of the upstream section is retrieved as the first section travel time interval. The average value is calculated based on the vehicle driving data of all probe vehicles 12, which passes through the upstream section in a predetermined time period. Further, the average value of the travel time interval of the downstream section is retrieved as the second section travel time interval. The average value is calculated based on the vehicle driving data of all probe vehicles 12, which passes through the downstream section in a predetermined time period.

The link travel time interval calculating unit 34 calculates the link travel time interval of the object link at every predetermined time period according to the selected calculation method based on the retrieved all section travel time interval and the retrieved first section travel time interval or the retrieved second section travel time interval.

The lint travel time interval calculating unit 34 retrieves the link travel time interval, which has been calculated with respect to the object link previously, from the link travel time interval data base 38 when the all section travel time interval, the first section travel time interval and the second section travel time interval, which are necessary for the selected calculation method with respect to the object link, are not retrieved. Thus, the unit 34 calculates the average value of the link travel time interval. Further, the unit 34 corrects the link travel time interval based on the environmental conditions such as the day of the week, the hours of a day and the weather, which are determined by the environmental condition determining unit 40 so that the link travel time interval of the object link is obtained.

The traffic information generating unit 36 generates the traffic information including the calculated link travel time interval of each link, and updates to the latest traffic information.

Next, the function of the traffic information generating system 10 according to the first embodiment will be explained. First, the probe vehicle information in each driving probe vehicle 12 is generated at predetermined time periods, and then, the information is transmitted to the base station 14 in wireless communication.

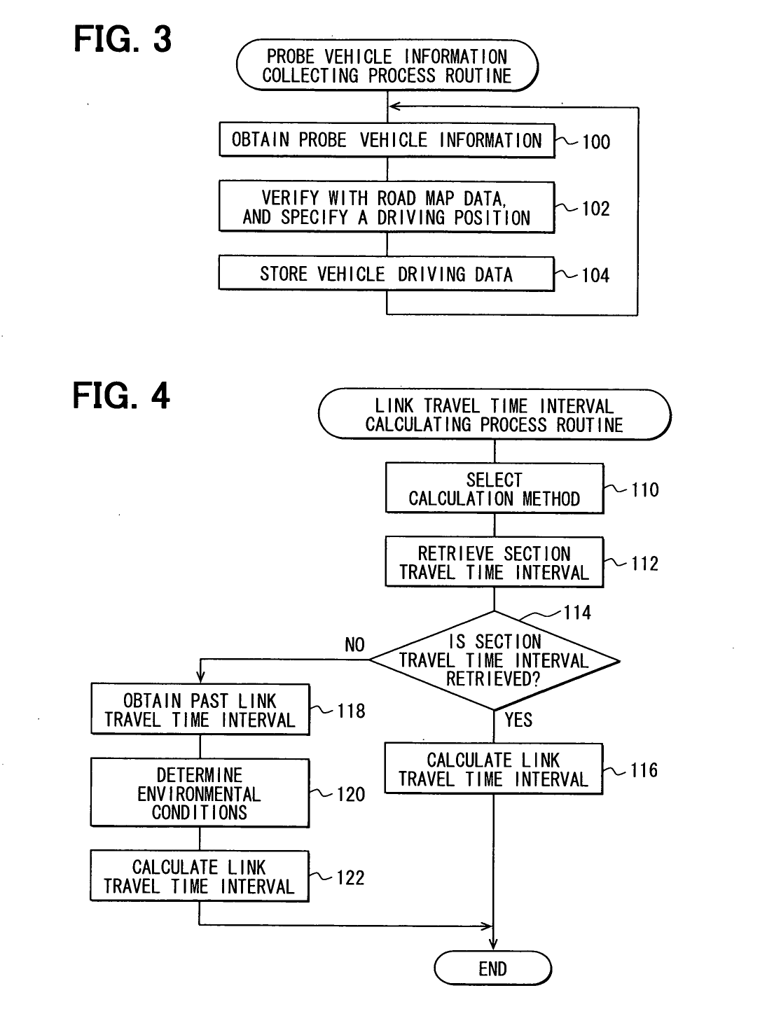

In the above case, the probe vehicle information collecting process routine shown in FIG. 3 is executed in the traffic information generating device 16.

In step 100, the probe vehicle information received via the communication line 18 is obtained. In step 102, the travel position data in the probe vehicle information obtained in step 100 is verified with the road map data preliminary prepared so that the travel position is specified on the road map.

Then, in step 104, the vehicle travel data including the travel position on the road map specified in step 102, the transit time in the probe vehicle information and the vehicle ID is generated, and then, stored in the vehicle travel data memorizing unit 30. It returns to step 100.

As described above, the probe vehicle information collecting process routine is executed, so that the vehicle travel data obtained from the probe vehicle information is collected as needed.

In the traffic information generating device 16, the link travel time calculating process routine shown in FIG. 4 is executed in each link on the road map at update intervals of the traffic information (for example, at five minute intervals). A case where the link travel time interval of a certain object link is calculated will be explained as follows.

In step 110, the calculation method of the link travel time interval of the object link is selected according to the traffic situation based on the vehicle travel data corresponding to the object link from five minutes ago to the present time, for example.

Next, in step 112, all section travel time interval, the first section travel time interval and the second section travel time interval, which are used for the calculation method selected in step 110, are retrieved based on the vehicle travel data from five minutes ago to the present time, the vehicle travel data relating to all sections, the upstream section, the downstream section, the upstream link and the downstream link and corresponding to the calculation method selected in step 110 and the object link.

In step 114, it is determined whether all section travel time interval, the first section travel time interval and the second section travel time interval are retrieved in step 112, which are used for the selected calculation method. When the all section travel time interval, the first section travel time interval and the second section travel time interval are obtained, in step 116, the link travel time interval of the object link is calculated according to the selected calculation method with using the all section travel time interval, the first section travel time interval and the second section travel time interval, which are retrieved in step 112. Then, the link travel time interval calculating process routine ends.

When it is determined in step 114 that the all section travel time interval, the first section travel time interval and the second section travel time interval used for the selected calculation method are not retrieved, the link travel time interval, which has been calculated previously with respect to the object link, is obtained from the link travel time interval data base 38 in step 118 so that the average value of the link travel time interval is calculated.

Then, in step 120, the environmental conditions of the object link are determined. In step 122, the average value of the link travel time interval obtained in step 118 is corrected in accordance with the environmental conditions determined in step 120. Thus, the link travel time interval of the object link is calculated. Then, the link travel time interval calculating process routine ends.

The link travel time interval calculating process routine is executed with respect to each link so that the link travel time interval of each link on the road map is calculated. Then, the traffic information including the calculated link travel time interval of each link as the current traffic information is updated.

The updated traffic information is transmitted to the navigation system mounted in each vehicle, for example. In the navigation system, a route search is executed based on the link travel time interval reflected on the change of the traffic situation in real time.

Experimental results executed by simulation in a case where the technique according to the present embodiment is used will be explained. In the simulation, with using the second calculation method shown in FIG. 2B, an experiment for calculating the section travel time interval including the object link is performed. Another experiment for measuring the link travel time interval of the object link without modification is performed as a comparison.

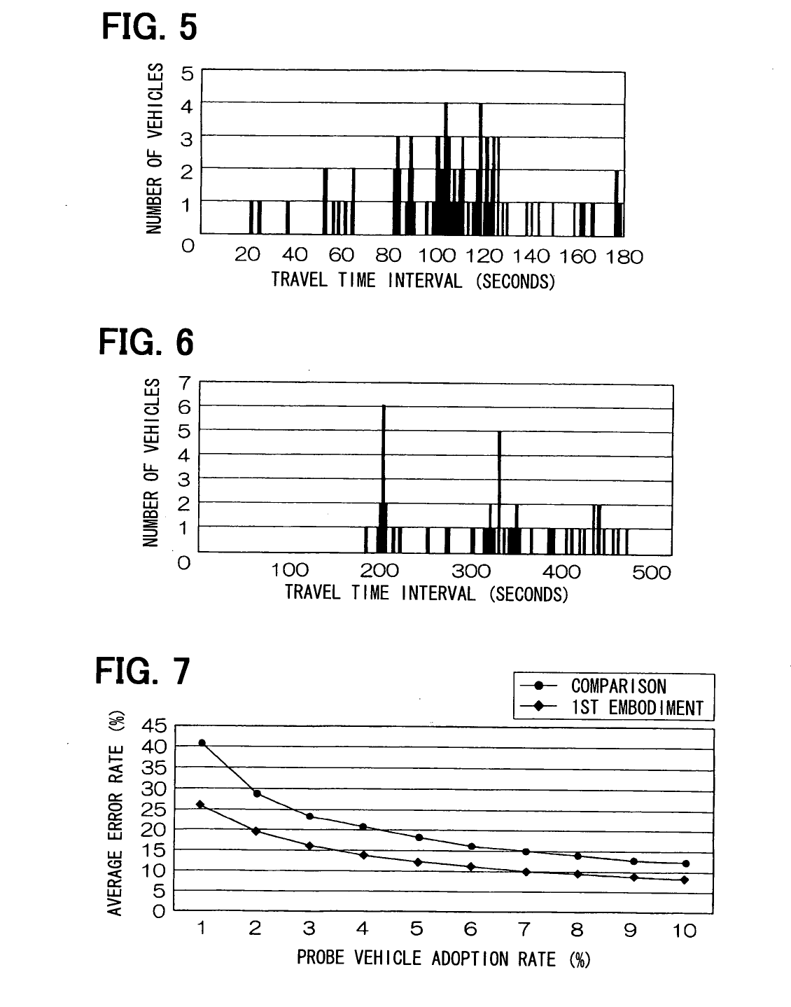

As shown in FIG. 5, the link travel time interval measured as the comparison is largely affected by the traffic light, so that variation is large. On the other hand, as shown in FIG. 6, the influence of the traffic light on the section travel time interval calculated by the second calculation method is averaged, and therefore, the variation is small. Further, as shown in FIG. 7, the average error rate of the link travel time interval is low in all probe vehicle adoption rate in a case where the time interval is calculated by the second calculation method. Further, when the probe vehicle adoption rate is low, difference of the average error rate of the link travel time interval becomes large.

As described above, in the traffic information generating system according to the first embodiment, a difference between the travel time interval of all sections including the upstream section and the downstream section of the object link in predetermined time period and a sum of the travel time interval of the upstream section and the travel time interval of the downstream section in the predetermined time period, a difference between a sum of the travel time interval of the link upstream section including the object link and the travel time interval of the link downstream section including the object link in a predetermined time period and the travel time interval of all sections in the predetermined time period, or a difference between the travel time interval of the link upstream section including the object link in a predetermined time period and the travel time interval of the upstream section in the predetermined time period is calculated. Thus, the link travel time interval reflecting on the traffic situation in real time is calculated accurately.

Further, the link travel time interval of the object link is calculated according to the selection calculation method based on the current traffic situation of the object link. Thus, the link travel time interval is calculated accurately. Further, in the system for collecting the probe vehicle information by the traffic information generating device via the wireless communication unit mounted on the probe vehicle, the generating device being arranged on the traffic information center side, the link travel time interval that is necessary to search a route of a vehicle navigation device is accurately calculated even under a condition that the probe vehicle adoption rate is low, or the number of traveling probe vehicles is small, so that the probe vehicle information is small. Further, the traffic information useful for selection of the minimum travel time route, which is required for the route search, can be provided in real time.

Further, in the section travel time interval including multiple traffic signal intersections, the influence of the traffic signals is averaged with respect to the vehicle travel. Thus, the variation of the section travel time interval is comparatively small, compared with the link travel time interval. With using this characteristic, the link travel time interval is calculated by the method for calculating the link travel time interval such that the difference between sectional travel time intervals of two different distances is calculated with using the section travel time interval including the link and the section travel time interval including the upstream or downstream of the link. Since the variation of the travel time interval caused by influence of the traffic light is averaged, the link travel time interval close to the average value of the link travel time intervals of all vehicles is obtained from this value, compared with the link travel time interval obtained from a single vehicle.

In the above embodiment, based on the average traveling speed calculated from the travel time interval of all sections, which is used for the second calculation method, an example case where the third calculation method is selected is explained. The embodiment is not limited to the example case. For example, when it is determined with using accumulated data of the past probe vehicle information and with reference to occurrence situation of the traffic jam or congestion obtained from conditions such as a day of the week, the hours of a day and the weather that the object link is a front link of a traffic jam (i.e., a link providing a bottle neck), the third calculation method for calculating the link travel time interval with using the section travel time interval including the object link and the upstream section may be selected.

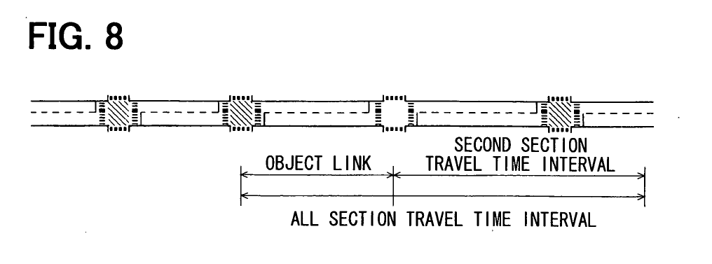

Further, the third calculation method is explained with an example case where the link travel time interval of the object link is calculated by subtracting the first section travel time interval of the upstream link from the travel time interval of all sections including the object link and the upstream section. The above embodiment is not limited to this example case. As shown in FIG. 8 and the following formula No. 4, the link travel time interval of the object link may be calculated by subtracting the second section travel time interval of the downstream link from the travel time interval of all sections including the object link and the downstream section disposed on the downstream side of the object link.

(link travel time interval of object link)=(all section travel time interval)−(second section travel time interval) F4

An example case where the calculation method of the link travel time interval is selected based on the current traffic situation of the object link, which is determined by the vehicle travel data in a predetermined time period, is explained. The embodiment is not limited to this example case. The calculation method of the link travel time interval may be selected based on the determined past traffic situation, which is prepared by determining the past traffic situation of the object link with using the accumulated data of the past probe vehicle information. In this case, the past traffic situation may be determined in view of the environmental conditions such as a day of the week and the hours of a day.

Next, a second embodiment will be explained. Here, a portion similar to the construction in the first embodiment has the same reference numeral and is not explained.

In the second embodiment, the vehicle travel data is collected based ob the output from multiple vehicle detectors arranged on a side of a road. This is different from the first embodiment.

The traffic information generating system according to the second embodiment includes multiple vehicle detectors (not shown) arranged on the side of the road. Each vehicle detector is connected to the traffic information generating device 16 via the communication line 18.

Multiple vehicle detectors are arranged on the side of the road at predetermined distance intervals. Each vehicle detector detects existence of a vehicle within a detection range of the road, and transmits the information showing detection of existence of the vehicle, information of detected time, information of the position of the vehicle detector, and the vehicle ID information for identifying the vehicle to the traffic information generating device 16 via the communication line 18.

The traffic information generating device 16 receives the information transmitted from the vehicle detector with using the information receiving unit 24. The information collecting unit 26 collects information received by the information receiving unit 24 from the vehicle detector. The road map verifying unit 28 verifies a setting position of the vehicle detector corresponding to the collected information with the road map shown in the road map data so that the position on the road map is specified at every time the unit 26 collects the information from the vehicle detector. Further, the vehicle travel data including the specified position on the road map (i.e., the travel position) and the time when the vehicle detector detects the existence of the vehicle (i.e., the transit time) is stored in the vehicle travel data memorizing unit 30.

Other constructions and functions of the traffic information generating system according to the second embodiment are similar to the first embodiment, and therefore, the constructions and functions are not explained.

Thus, in a system such that the output from the vehicle detector is collected by the traffic information generating device arranged on the traffic information center side via the communication line, the link travel time interval necessary for the route search of the vehicle navigation is accurately calculated.

Here, in the first embodiment and the second embodiment, the link travel time interval may be calculated with using one of the first calculation method, the second calculation method and the third calculation method without selecting one of the first calculation method, the second calculation method and the third calculation method. Alternatively, one of combinations may be selected among combinations of two types of the calculation methods of the first calculation method, the second calculation method and the third calculation method.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A link travel time calculation device comprising:
a collection element for collecting a travel position and a transit time at the travel position in each vehicle, which are measured individually among a plurality of vehicles; and
a link travel time calculation element,
wherein the link travel time calculation element calculates a total travel time interval of all sections based on the travel position and the transit time, which are collected by the collection element in a predetermined time period,
wherein the all sections includes an object link, an upstream section disposed on an upstream side of the object link, and a downstream section disposed on a downstream side of the object link,
wherein the link travel time calculation element calculates a first travel time interval of the upstream section based on the travel position and the transit time,
wherein the link travel time calculation element calculates a second travel time interval of the downstream section based on the travel position and the transit time, and
wherein the link travel time calculation element calculates a travel time interval of the object link with respect to the predetermined time period by subtracting a sum of the first travel time interval and the second travel time interval from the total travel time interval.

2. The link travel time calculation device according to claim 1,
wherein each vehicle includes a GPS sensor and a wireless communication unit, and
wherein the collection element collects the travel position and the transmit time, which are transmitted from each vehicle and measured by the GPS sensor in each vehicle.

3. The link travel time calculation device according to claim 2,
wherein the collection element verifies the travel position measured in each vehicle with road map data, which is preliminary prepared, so that the collection element collects the travel position of each vehicle as a position of a road map.

4. A link travel time calculation device comprising:
a collection element for collecting a travel position and a transit time at the travel position in each vehicle, which are measured individually among a plurality of vehicles; and
a link travel time calculation element,
wherein the link travel time calculation element calculates a third travel time interval of a link upstream section based on the travel position and the transit time, which are collected by the collection element in a predetermined time period,
wherein the link upstream section includes an object link and an upstream section disposed on an upstream side of the object link,
wherein the link travel time calculation element calculates a fourth travel time interval of a link downstream section based on the travel position and the transit time, which are collected by the collection element in the predetermined time period,
wherein the link downstream section includes the object link and a downstream section disposed on a downstream side of the object link,
wherein the link travel time calculation element calculates a total travel time interval of all sections based on the travel position and the transit time,
wherein the all sections include the object link, the upstream section and the downstream section, and
wherein the link travel time calculation element calculates a travel time interval of the object link with respect to the predetermined time period by subtracting the third travel time interval and the fourth travel time interval from the total travel time interval.

5. The link travel time calculation device according to claim 4,
wherein each vehicle includes a GPS sensor and a wireless communication unit, and
wherein the collection element collects the travel position and the transmit time, which are transmitted from each vehicle and measured by the GPS sensor in each vehicle.

6. The link travel time calculation device according to claim 5,
wherein the collection element verifies the travel position measured in each vehicle with road map data, which is preliminary prepared, so that the collection element collects the travel position of each vehicle as a position of a road map.

7. A link travel time calculation device comprising:
a collection element for collecting a travel position and a transit time at the travel position in each vehicle, which are measured individually among a plurality of vehicles; and
a link travel time calculation element,
wherein the link travel time calculation element calculates a fifth travel time interval of a link downstream section based on the travel position and the transit time, which are collected by the collection element in a predetermined time period,
wherein the link downstream section includes an object link and a downstream section disposed on a downstream side of the object link,
wherein the link travel time calculation element calculates a sixth travel time interval of the downstream section based on the travel position and the transit time,
wherein the link travel time calculation element calculates a travel time interval of the object link with respect to the predetermined time period by subtracting the sixth travel time interval from the fifth travel time interval.

8. The link travel time calculation device according to claim 7,
wherein each vehicle includes a GPS sensor and a wireless communication unit, and
wherein the collection element collects the travel position and the transmit time, which are transmitted from each vehicle and measured by the GPS sensor in each vehicle.

9. The link travel time calculation device according to claim 8,
wherein the collection element verifies the travel position measured in each vehicle with road map data, which is preliminary prepared, so that the collection element collects the travel position of each vehicle as a position of a road map.

10. A link travel time calculation device comprising:
a collection element for collecting a travel position and a transit time at the travel position in each vehicle, which are measured individually among a plurality of vehicles; and
a link travel time calculation element,
wherein the link travel time calculation element calculates a seventh travel time interval of a link upstream section based on the travel position and the transit time, which are collected by the collection element in a predetermined time period,
wherein the link upstream section includes an object link and an upstream section disposed on an upstream side of the object link,
wherein the link travel time calculation element calculates an eighth travel time interval of the upstream section based on the travel position and the transit time,
wherein the link travel time calculation element calculates a travel time interval of the object link with respect to the predetermined time period by subtracting the eighth travel time interval from the seventh travel time interval.

11. The link travel time calculation device according to claim 10,
wherein each vehicle includes a GPS sensor and a wireless communication unit, and
wherein the collection element collects the travel position and the transmit time, which are transmitted from each vehicle and measured by the GPS sensor in each vehicle.

12. The link travel time calculation device according to claim 11,
wherein the collection element verifies the travel position measured in each vehicle with road map data, which is preliminary prepared, so that the collection element collects the travel position of each vehicle as a position ea road map.

13. A link travel time calculation device comprising:
a collection element for collecting a travel position and a transit time at the travel position in each vehicle, which are measured individually among a plurality of vehicles;
a calculation method selection element; and
a link travel time calculation element,
wherein the calculation method selection element selects one of a first calculation method, a second calculation method, a third calculation method and a fourth calculation method according to a current traffic situation of an object link and a past traffic situation of the object link,
wherein the link travel time calculation element calculates a travel time interval of the object link with respect to a predetermined time period according to the selected one of the first to fourth calculation methods,
wherein the first calculation method includes:
calculating a total travel time interval of all sections based on the travel position and the transit time, which are collected by the collection element in the predetermined time period, wherein the all sections includes the object link, an upstream section disposed on an upstream side of the object link, and a downstream section disposed on a downstream side of the object link;
calculating a first travel time interval of the upstream section based on the travel position and the transit time;
calculating a second travel time interval of the downstream section based on the travel position and the transit time, and
calculating a travel time interval of the object link with respect to the predetermined time period by subtracting a sum of the first travel time interval and the second travel time interval from the total travel time interval,
wherein the second calculation method includes:
calculating a third travel time interval of a link upstream section based on the travel position and the transit time, wherein the link upstream section includes the object link and the upstream section disposed on the upstream side of the object link;
calculating a fourth travel time interval of a link downstream section based on the travel position and the transit time, wherein the link downstream section includes the object link and the downstream section disposed on the downstream side of the object link;
calculating the total travel time interval of all sections based on the travel position and the transit time, wherein the all sections includes the object link, the upstream section and the downstream section; and
calculating the travel time interval of the object link with respect to the predetermined time period by subtracting the third travel time interval and the fourth travel time interval from the total travel time interval,
wherein the third calculation method includes:
calculating a fifth travel time interval of the link downstream section based on the travel position and the transit time; wherein the link downstream section includes the object link and the downstream section disposed on the downstream side of the object link;
calculating a sixth travel time interval of the downstream section based on the travel position and the transit time; and
calculating the travel time interval of the object link with respect to the predetermined time period by subtracting the sixth travel time interval from the fifth travel time interval,
wherein the fourth calculation method includes:
calculating a seventh travel time interval of the link upstream section based on the travel position and the transit time, wherein the link upstream section includes the object link and the-upstream section disposed on the upstream side of the object link;
calculating an eighth travel time interval of the upstream section based on the travel position and the transit time; and
calculating the travel time interval of the object link with respect to the predetermined time period by subtracting the eighth travel time interval from the seventh travel time interval.

14. The link travel time calculation device according to claim 13,
wherein each vehicle includes a GPS sensor and a wireless communication unit, and
wherein the collection element collects the travel position and the transmit time, which are transmitted from each vehicle and measured by the GPS sensor in each vehicle.

15. The link travel time calculation device according to claim 14,
wherein the collection element verifies the travel position measured in each vehicle with road map data, which is preliminary prepared, so that the collection element collects the travel position of each vehicle as a position of a road map.

16. A method for calculating a travel time interval of an object link comprising:
collecting a travel position and a transit time at the travel position in each vehicle, which are measured individually among a plurality of vehicles;
calculating a total travel time interval of all sections based on the travel position and the transit time, which are collected in a predetermined time period, wherein the all sections includes the object link, an upstream section disposed on an upstream side of the object link, and a downstream section disposed on a downstream side of the object link;
calculating a first travel time interval of the upstream section based on the travel position and the transit time;
calculating a second travel time interval of the downstream section based on the travel position and the transit time, and
calculating the travel time interval of the object link with respect to the predetermined time period by subtracting a sum of the first travel time interval and the second travel time interval from the total travel time interval.

17. A method for calculating a travel time interval of an object link comprising:
collecting a travel position and a transit time at the travel position in each vehicle, which are measured individually among a plurality of vehicles;
calculating a third travel time interval of a link upstream section based on the travel position and the transit time, which are collected in a predetermined time period, wherein the link upstream section includes the object link and an upstream section disposed on an upstream side of the object link;
calculating a fourth travel time interval of a link downstream section based on the travel position and the transit time, wherein the link downstream section includes the object link and a downstream section disposed on a downstream side of the object link;
calculating a total travel time interval of all sections based on the travel position and the transit time, wherein the all sections includes the object link, the upstream section and the downstream section; and
calculating the travel time interval of the object link with respect to the predetermined time period by subtracting the third travel time interval and the fourth travel time interval from the total travel time interval.

18. A method for calculating a travel time interval of an object link comprising:
collecting a travel position and a transit time at the travel position in each vehicle, which are measured individually among a plurality of vehicles;
calculating a fifth travel time interval of a link downstream section based on the travel position and the transit time, which are collected in a predetermined time period, wherein the link downstream section includes the object link and a downstream section disposed on a downstream side of the object link;
calculating a sixth travel time interval of the downstream section based on the travel position and the transit time; and
calculating the travel time interval of the object link with respect to the predetermined time period by subtracting the sixth travel time interval from the fifth travel time interval.

19. A method for calculating a travel time interval of an object link comprising:
collecting a travel position and a transit time at the travel position in each vehicle, which are measured individually among a plurality of vehicles;
calculating a seventh travel time interval of a link upstream section based on the travel position and the transit time, which are collected in a predetermined time period, wherein the link upstream section includes the object link and an upstream section disposed on an upstream side of the object link;
calculating an eighth travel time interval of the upstream section based on the travel position and the transit time; and
calculating the travel time interval of the object link with respect to the predetermined time period by subtracting the eighth travel time interval from the seventh travel time interval.

20. A method for calculating a travel time interval of an object link comprising:
collecting a travel position and a transit time at the travel position in each vehicle, which are measured individually among a plurality of vehicles;
selecting one of a first calculation method, a second calculation method, a third calculation method and a fourth calculation method according to a current traffic situation of the object link and a past traffic situation of the object link; and
calculating the travel time interval of the object link with respect to a predetermined time period according to the selected one of the first to fourth calculation methods,
wherein the first calculation method includes:
calculating a total travel time interval of all sections based on the travel position and the transit time, which are collected by the collection element in the predetermined time period, wherein the all sections includes the object link, an upstream section disposed on an upstream side of the object link, and a downstream section disposed on a downstream side of the object link;
calculating a first travel time interval of the upstream section based on the travel position and the transit time;
calculating a second travel time interval of the downstream section based on the travel position and the transit time, and
calculating a travel time interval of the object link with respect to the predetermined time period by subtracting a sum of the first travel time interval and the second travel time interval from the total travel time interval,
wherein the second calculation method includes:
calculating a third travel time interval of a link upstream section based on the travel position and the transit time, wherein the link upstream section includes the object link and the upstream section disposed on the upstream side of the object link;
calculating a fourth travel time interval of a link downstream section based on the travel position and the transit time, wherein the link downstream section includes the object link and the downstream section disposed on the downstream side of the object link;
calculating the total travel time interval of all sections based on the travel position and the transit time, wherein the all sections includes the object link, the upstream section and the downstream section; and
calculating the travel time interval of the object link with respect to the predetermined time period by subtracting the third travel time interval and the fourth travel time interval from the total travel time interval,
wherein the third calculation method includes:
calculating a fifth travel time interval of the link downstream section based on the travel position and the transit time; wherein the link downstream section includes the object link and the downstream section disposed on the downstream side of the object link;
calculating a sixth travel time interval of the downstream section based on the travel position and the transit time; and
calculating the travel time interval of the object link with respect to the predetermined time period by subtracting the sixth travel time interval from the fifth travel time interval,
wherein the fourth calculation method includes:
calculating a seventh travel time interval of the link upstream section based on the travel position and the transit time, wherein the link upstream section includes the object link and the upstream section disposed on the upstream side of the object link;
calculating an eighth travel time interval of the upstream section based on the travel position and the transit time; and
calculating the travel time interval of the object link with respect to the predetermined time period by subtracting the eighth travel time interval from the seventh travel time interval.
